(19) United States
(12) Patent Application Publication
(10) Pub. No.: US 2011/0133428 A1
(43) Pub. Date: Jun. 9, 2011

(54) STEERING SAFETY MECHANISM FOR BICYCLE

(76) Inventor: JUNG-CHAI HSIEH, Yuanli Township (TW)

(21) Appl. No.: 12/632,812

(22) Filed: Dec. 8, 2009

(51) Int. Cl. B62K 21/08

(52) U.S. Cl. 280/276

(57) ABSTRACT

A steering safety mechanism is provided for a bicycle and includes a frame, a steering stem, at least one first fastener, at least one second fastener, and a damping element. The frame includes a head tube portion. An end of the steering stem is received through the head tube portion. The first fastener is attached to the frame, and the second fastener is attached to the steering stem. The damping element has a first end attached to the first fastener and a second end attached to the second fastener.

### TECHNICAL FIELD OF THE INVENTION

The present invention generally relates to a bicycle, and more particularly to a steering safety mechanism for a bicycle.

### DESCRIPTION OF THE PRIOR ART

With the fast raise of fuel price and the tendency of environmental conservation, as well as the prevailing of LOHAS, bicycle riding becomes more and more popular recently and is often considered an excellent way of release of living pressure. Bicycle riding not only provides the effect of exercising and entertainment, but is also good for activity between parents and children.

Referring to FIG. 1 of the attached drawings, an ordinary bicycle 1 changes moving direction by a rider operating a handlebar 11 to rotate a steering stem 12, which in turn drives a front fork 13 to steer a front wheel 14. The handlebar 11 and the steering stem 12 are allowed to make a rotation of 180 degrees, if they are not interfered with by brake cables 15, and they can at least do a rotation of 90 degrees under the condition of being interfered with by the brake cables 15. This arrangement allows the steering stem 12 to take an undesired large angle steering that may exceed 90 degrees in case of an unexpected condition, such as losing control in moving downhill, in the riding of bicycle 1. Such a large angle steering operation may cause an unexpected immediate stop of the front wheel of the bicycle 1 or the front wheel making a large angle of direction change, both preventing the bicycle from smoothly moving forward, eventually leading to tipping and hurting the rider.

Thus, it is desired to provide a steering safety mechanism for bicycles in order to alleviate the above problems and enhance bicycle riding safety. This is major challenge that the bicycle industry is currently facing.

### SUMMARY OF THE INVENTION

In view of the above problem, an object of the present invention is to provide a bicycle steering safety mechanism that helps improving riding safety.

To achieve the above object, in accordance with the present invention, a steering safety mechanism is provided for a bicycle. The steering safety mechanism comprises a frame, a steering stem, at least one first fastener, at least one second fastener, and a damping element. The frame comprises a head tube portion. The steering stem is partially received through the head tube portion and the steering stem extends beyond an end of the head tube portion to connect to a front fork for coupling with a front wheel. The first fastener is attached to the frame, and the second fastener is attached to the steering stem. The damping element has a first end attached to the first fastener and a second end attached to the second fastener.

In an embodiment of the present invention, the damping element comprises a spring.

In an embodiment of the present invention, the steering safety mechanism further comprises a stop and a rotation limiting element. The stop is mounted to an outer circumference of the head tube portion of the frame, and the rotation limiting element is mounted to the steering stem to correspond to the stop, whereby when the steering stem is rotated to a predetermined angle, the stop interferes with the rotation limiting element.

In an embodiment of the present invention, the steering safety mechanism further comprises a stop and a rotation limiting element. The stop is mounted to the steering stem, and the rotation limiting element is mounted to an outer circumference of the head tube portion of the frame to correspond to the stop, whereby when the steering stem is rotated to a predetermined angle, the stop interferes with the rotation limiting element.

With the structure described above, the present invention features a damping element that is mounted to a bicycle to provide a resistance against a steering operation of the bicycle, and the greater the rotation angle of the steering operation gets, the greater the resistance provided by the damping element will be. This effectively prevents the bicycle head from over-steering that generates an excessive rotation angle due to insufficiency of the resistance, leading to lose of control of the bicycle and potential risk of hurting the rider. Further, a stop and a rotation limiting element are further included to limit the rotation angle of bicycle steering operation in order to further enhance bicycle riding safety.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a portion of a known structure of a conventional bicycle.

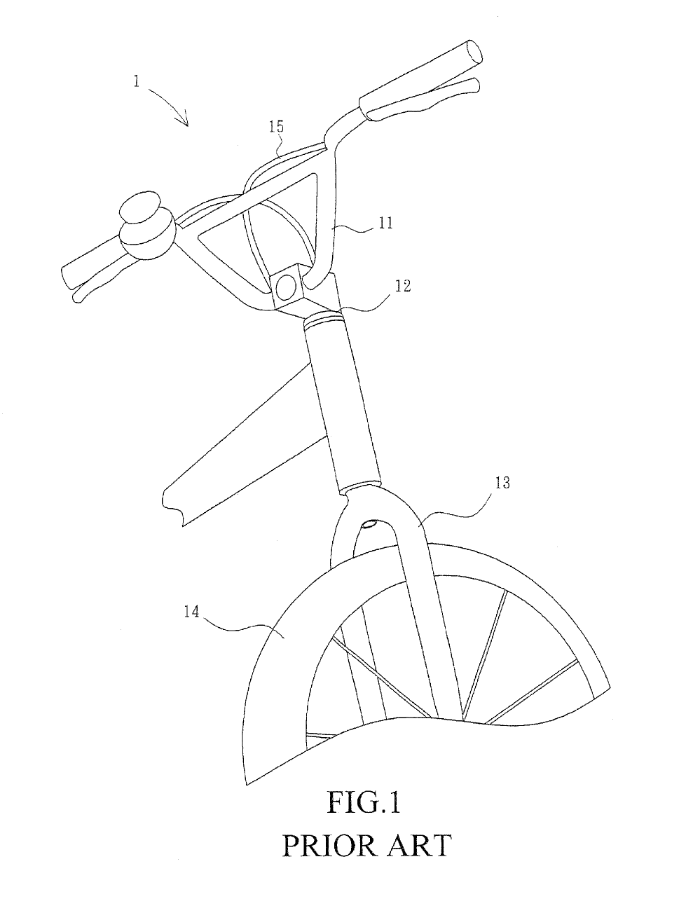

FIG. 2 is a schematic view showing a bicycle steering safety mechanism according to a first embodiment of the present invention.

FIG. 3 is a schematic view showing a bicycle steering safety mechanism according to a second embodiment of the present invention.

FIG. 4 is a schematic view showing a bicycle steering safety mechanism according to a third embodiment of the present invention.

FIG. 5 is a schematic view showing a bicycle steering safety mechanism according to a fourth embodiment of the present invention.

FIG. 6 is a schematic view showing a bicycle steering safety mechanism according to a fifth embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

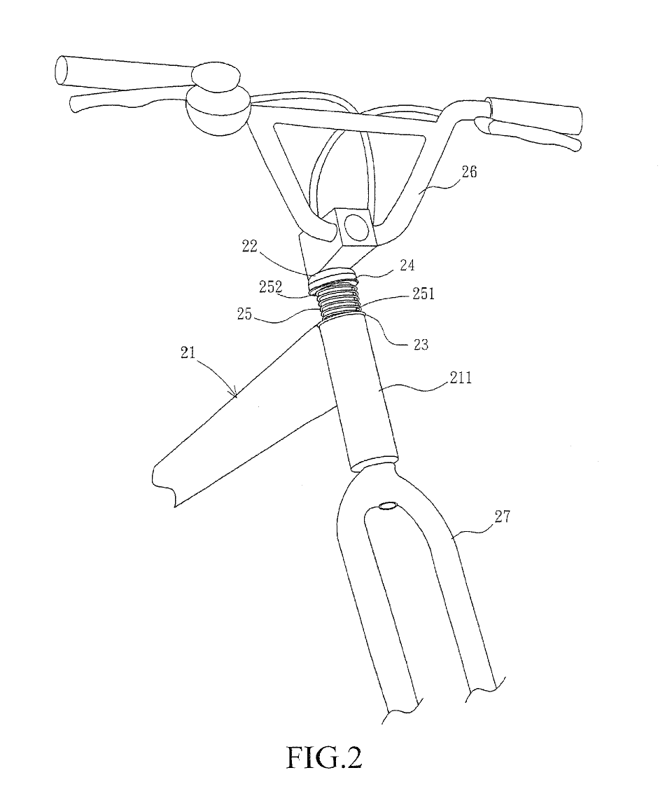

With reference to FIG. 2, a steering safety mechanism according to a first preferred embodiment of the present invention, generally designated at 1, is provided for a bicycle, which comprises a frame 21 and a steering stem 22 between which at least one first fastener 23, at least one second fastener 24, and a damping element 25 are arranged.

The frame 21 comprises a head tube portion 211, which is arranged between a handlebar 26 and a front fork 27. The steering stem 22 is partially received through the head tube portion 211 and is coupled to the handlebar 26 and the front fork 27.

In the instant embodiment, the first fastener 23 and the second fastener 24 are illustrated as a single element serving only as an example thereof. As shown in FIG. 2, the first fastener 23 is attached to the head tube portion 211 of the frame 21, and the second fastener 24 is attached to a portion of the steering stem 22 that is close to the head tube portion 211. In the instant embodiment, the first fastener 23 and the second fastener 24 can be elements that are externally mounted, or they can be integrally formed with the frame 21. The present invention is not limited to any specific form of the fasteners.

The damping element 25 has a first end 251 and a second end 252. The first end 251 is connected to the first fastener 23, while the second end 252 is connected to the second fastener 24. In other wards, the first end 251 of the damping element 25 is fixed to the first fastener 23 and the second end 252 is fixed to the second fastener 24. In the instant embodiment, the damping element 25 is illustrated as a spring for an illustrative example. It is apparent that other elements or devices that exhibit similar damping effect can be used, such as a pneumatic device or a hydraulic device.

As shown in FIG. 2, when a bicycle rider turns the handlebar, a relative rotation is induced between the steering stem 22 and the head tube portion 211. The greater the rotation angle of the relative rotation becomes, the greater the resistance induced by the damping element 25 will be. Thus, a bicycle equipped with the steering safety mechanism can be prevented from making a large angle steering operation. This helps to prevent the bicycle from tipping over and riding safety can be enhanced.

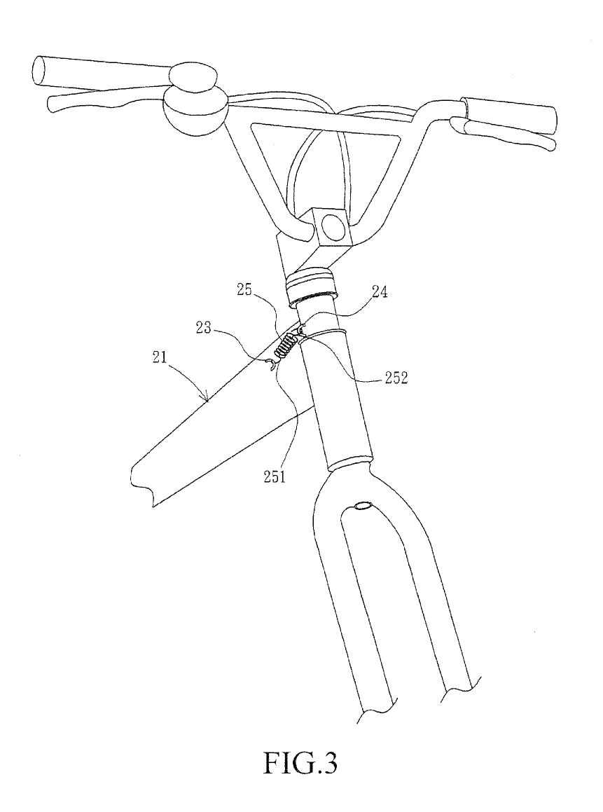

Referring to FIG. 3, a bicycle steering safety mechanism according to a second embodiment of the present invention is shown. A difference between the second embodiment and the first embodiment is that the first fastener 23 of the second embodiment is not attached to the head tube portion 211, and is instead attached to a portion of the frame 21 that is distant from the head tube portion 211. Apparently, the first fastener 23 can be attached to any suitable location, including the head tube portion 211, and the second embodiment is provided for illustration of different ways of embodying the present invention.

Further, in the instant embodiment, both sides of the frame 21 are each provided with a first fastener 23, a second fastener 24, and a damping element 25. In other words, the bicycle steering safety mechanism may comprise two sets of first fastener 23, second fastener 24, and damping element 25, which are respectively set at two opposite sides of the frame 21 to increase the effect of damping.

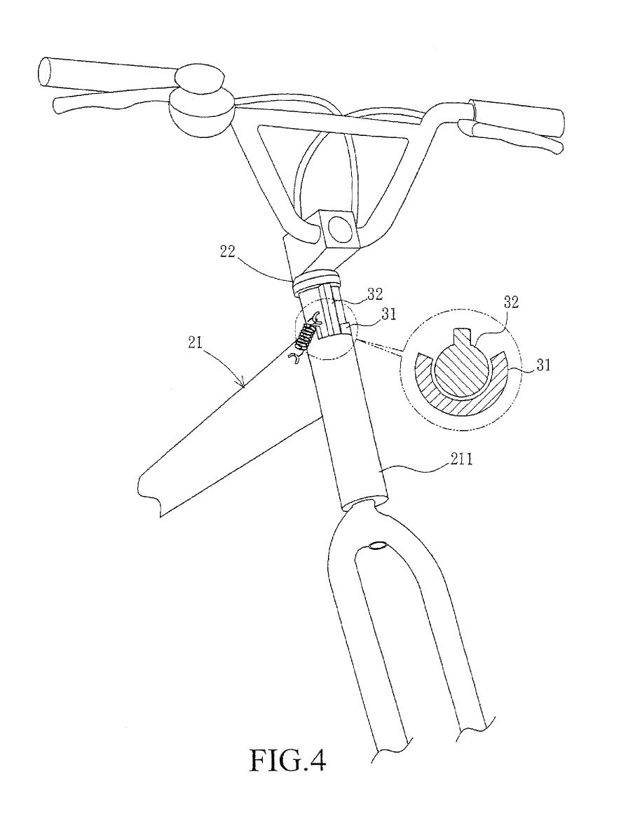

Referring to FIG. 4, a bicycle steering safety mechanism according to a third embodiment of the present invention is shown. A difference between the third embodiment and the two previous embodiments is that in the third embodiment, a stop 32 and a rotation limiting element 31 are included in the steering safety mechanism. The stop 32 is mounted to the steering stem 22, while the rotation limiting element 31 is mounted to and partially extends along an outer circumference of the head tube portion 211 of the frame 21 to correspond to the stop 32. When the steering stem 22 is being rotated, upon reaching a predetermined angle, the rotation of the steering stem 22 will be interfered with by the rotation limiting element 31 engaging the stop 32. In this way, the rotation angle of the steering stem 22 is constrained and excessive rotation caused by over-steering of bicycle that leads to accident will be avoided even when a bicycle in operation is losing control and taking an undesired steering action.

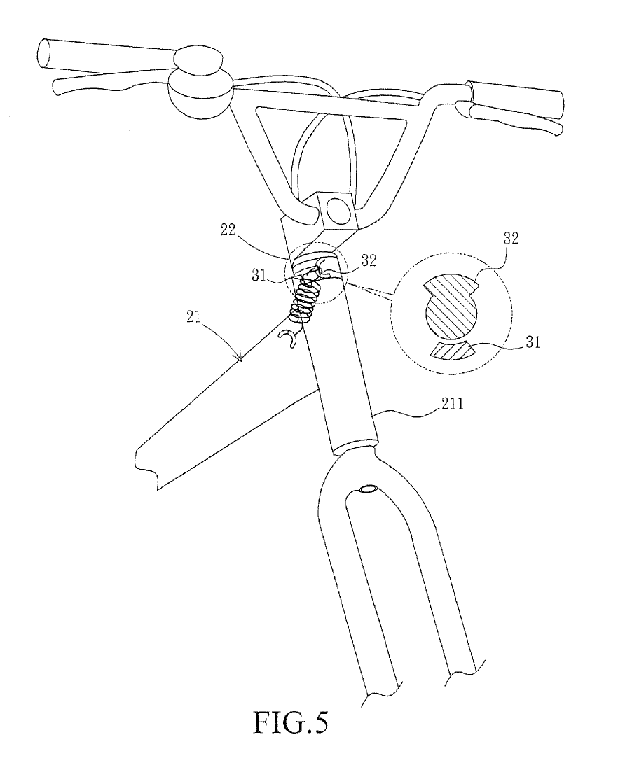

Referring to FIG. 5, a bicycle steering safety mechanism according to a fourth embodiment of the present invention is shown. The fourth embodiment is different from the third embodiment in that the stop 32 is mounted to an outer circumference of the head tube portion 211 of the frame 21, while the rotation limiting element 31 is mounted to the steering stem 22 to correspond to the stop 32. When the rotation of the steering stem 22 reaches a given angle, the rotation limiting element 31 will interfere with the stop 32.

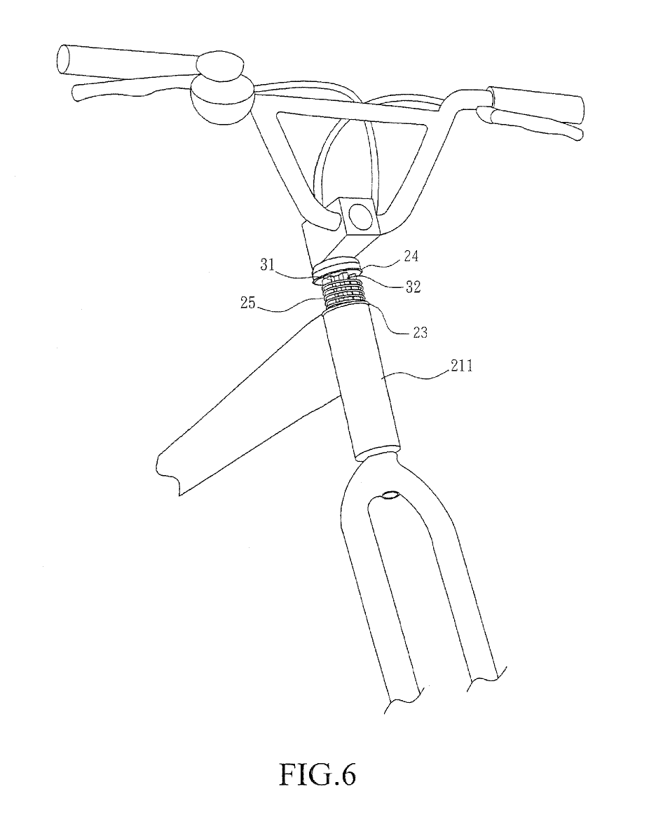

Referring to FIG. 6, a bicycle steering safety mechanism according to a fifth embodiment of the present invention is shown, in which the first fastener 23, the second fastener 24, and the damping element 25 of the first embodiment are used in combination with the stop 32 and the rotation limiting element 31.

To summarize, the present invention provides a bicycle steering safety mechanism that comprises a damping element to induce a resistance against a steering operation of a bicycle, whereby when the rotation angle gets greater, the resistance induced by the damping element becomes greater, in order to prevent excessive rotation angle of over-steering due to excessively small steering resistance that leads to losing control of bicycle and potential risk of hurting the bicycle rider. Further, a stop and a rotation limiting element are further included to limit the rotation angle of bicycle steering operation in order to further enhance bicycle riding safety

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A bicycle steering safety mechanism, comprising:
a frame, which comprises a head tube portion;
a steering stem, which is partially received through the head tube portion;
at least one first fastener, which is attached to the frame;
at least one second fastener, which is attached to the steering stem; and
a damping element, which has a first end attached to the first fastener and a second end attached to the second fastener.

2. The bicycle steering safety mechanism according to claim 1, wherein the damping element comprises a spring.

3. The bicycle steering safety mechanism according to claim 1 further comprising:
a stop, which is mounted to an outer circumference of the head tube portion of the frame; and
a rotation limiting element, which is mounted to the steering stem to correspond to the stop;
wherein when the steering stem is rotated to a predetermined angle, the rotation limiting element interferes with the stop.

4. The bicycle steering safety mechanism according to claim 1 further comprising:
a stop, which is mounted to the steering stem; and
a rotation limiting element, which is mounted to an outer circumference of the head tube portion of the frame to correspond to the stop;
wherein when the steering stem is rotated to a predetermined angle, the rotation limiting element interferes with the stop.

5. The bicycle steering safety mechanism according to claim 1, wherein the damping element induces a greater resistance when the steering stem rotates a greater angle.
